(19) United States
(12) Patent Application Publication
(10) Pub. No.: US 2025/0297198 A1
(43) Pub. Date: Sep. 25, 2025

(54) PACKAGED COMPOSITION WITH MIXED PARTICLES

(71) Applicant: The Procter & Gamble Company, Cincinnati, OH (US)

(72) Inventors: Pu ZHAO, Beijing (CN); Rui SHEN, Beijing (CN); Yanjie WENG, Beijing (CN); Kristin Rhedrick WILLIAMS, West Chester, OH (US); Chistopher Gerold STOLTZ, Mason, OH (US)

(21) Appl. No.: 19/084,848

(22) Filed: Mar. 20, 2025

(30) Foreign Application Priority Data
Mar. 22, 2024 (WO) PCT/CN2024/083242
Feb. 17, 2025 (WO) PCT/CN2025/077600

(51) Int. Cl. C11D 17/06; C11D 3/50

(52) U.S. Cl. CPC C11D 17/06; C11D 3/505

(57) ABSTRACT

A composition including a plurality of first particles, and a plurality of second particles. Each of said first particles has a mass from 5 mg to 500 mg; each of said first particles has a maximum dimension of less than about 10 mm, and each of said first particles has a first shape selected from the group consisting of hemispherical, compressed hemispherical or heightened hemispherical. Each of said second particles has a mass equal to or larger than the mass of the first particles; and each of said second particles has a second shape which is different from the first shape of the first particle. Each of said second particles has an aspect ratio of more than 1 and less than 10. The plurality of first particles and the plurality of second particles are in a package.

### TECHNICAL FIELD

This disclosure is related to a packaged composition containing mixed particles.

### BACKGROUND

Scent is recognized to be a source of pleasure to consumers when they do their laundry. Consumers may associate certain scents with performance of the laundry products and as an indicator of quality of the laundry products. Laundry products that provide a pleasant or enhanced scent experience to the consumer when she dispenses the laundry product, transfers a load of wet laundry from the washer to the dryer or to a drying rack or line, or when she wears the clothing meet this consumer need.

Correspondingly, perfumed particles are becoming increasingly popular as a laundry scent additive. The perfumed particles can be used to impart new scent to, or enhance existing scent in, the articles being washed.

Different shape of the particles can provide visual or aesthetical attraction to consumers, as well as show signals of different benefits of the particles. However, there is challenge for combining particles with different shapes to maintain good flowability during manufacturing and storage. At the same time, it is also a challenge to provide a mixed particle composition which avoid potential segregation during storage and usage in consumer's house.

Therefore, there is a continuous need for a mixed laundry composition with mix particles having different characteristics, especially different shapes, which exhibits desired flowability and avoids potential segregation.

### SUMMARY

The fabric care composition described herein provide mixed particles having different size or shape, so that the consumer can receive fresh visual pleasure or a signal for different benefit, while at the same time the mixed particles are uniformly blended with desired flowability and segregation stability.

The present disclosure provides a fabric care composition, comprising:
i) a plurality of first particles, wherein each of said first particles has a mass from 5 mg to 500 mg; each of said first particles has a maximum dimension of less than about 10 mm, and each of said first particles has a first shape selected from the group consisting of hemispherical, compressed hemispherical or heightened hemispherical; and
ii) a plurality of second particles, wherein each of said second particles has a mass equal to or larger than the mass of the first particle, and wherein each of said second particles has a second shape which is different from the first shape of the first particle, wherein each of said second particles has an aspect ratio of more than 1 and less than 10,
wherein the plurality of first particles and the plurality of second particles are in a package.

Preferably, each of said second particles has an aspect ratio from more than 1 to 7, preferably from more than 1 to 5. Preferably, the plurality of the first particles is present in amount of from 50% to 95%, preferably from 70% to 90%, by weight in the composition, and the plurality of the second particles is present in amount of from 5% to 50%, preferably from 10% to 30%, by weight in the composition. Preferably, the mass of each of the second particles is from 5 mg to 5 g; wherein the mass ratio between each of the second particles and each of the first particles is from 1:1 to 50:1, and preferably from 1:1 to 20:1, and more preferably from 1:1 to 10:1.

Preferably, the maximum dimension of the second particle is no less than the maximum dimension of the first particles, and preferably the ratio of the maximum dimension of the first particle and the second particles is from 1:1 to 1:10, and preferably from 1:1 to 1:5, and more preferably from 1:1.1 to 1:3.

Preferably, the volume ratio of each first particle to each second particle is from 1:1 to 1:50, preferably from 1:1.1 to 1:25, more preferably from 1:1.5 to 1:10.

Preferably, substantially all of said first particles have a substantially flat base and a height (H) measured orthogonal to said base and together said first particles have a distribution of heights, wherein said distribution of heights has a mean height between 1 mm and 5 mm and a height standard deviation less than 0.3 mm.

Preferably, substantially all of said second particles have a maximum dimension and a maximum secondary dimension orthogonal to the maximum dimension, wherein the ratio of maximum dimension to the maximum secondary dimension is greater than about 1.2.

Preferably, each of the first particles has a mass from 5 mg to 450 mg, preferably from 10 mg to 200 mg, more preferably from 15 mg to 150 mg; wherein each of the second particles has a mass from 10 mg to 2 g, preferably from 20 mg to 1g, and more preferably from 25 mg to 500 mg.

Preferably, each of said first particles and said second particles comprise one or more ingredients selected from a perfume ingredient, a water-soluble carrier, a surfactant, a fabric softener active, cationic polymer, malodor control agent, colorants, enzymes, bleaching agents, and combinations thereof.

Preferably, each of said first particles comprises a first perfume ingredient and a first water-soluble carrier, and each of said second particles comprises a second perfume ingredient and a second water-soluble carrier, wherein the first perfume ingredient and the second perfume ingredient comprises free perfumes, or friable perfume microcapsules, or preferably both, and the first water-soluble carrier and the second water-soluble carrier is each selected from the group consisting of polyethylene glycol, polymer, proteins, sugar, starch, saccharides, polysaccharides, water-soluble or water dispensable fillers, and combinations thereof.

The present disclosure provides a fabric care composition, comprising:
i) 50% to 95% by weight of a plurality of first particles, wherein each of said first particles has a mass from 5 mg to 500 mg; each of said first particles has a maximum dimension of less than about 10 mm, each of said first particles has a first shape selected from the group consisting of hemispherical, compressed hemispherical or heightened hemispherical, wherein said first particles comprise a perfume ingredient; and
ii) 10% to 50% by weight of a plurality of second particles, wherein each of said second particles has a mass equal to or larger than the mass of the first particle; each of said second particles has an aspect ratio of more than 1 and less than 10, wherein said second particles comprise one or more ingredients selected from perfume ingredient, water-soluble carrier, surfactant, fabric softener active, cationic polymer, malodor control agent, colorants, enzymes, bleaching agents, and combinations thereof;
wherein the plurality of first particles and the plurality of second particles are in a package.

The present disclosure provides a process for treating an article of clothing comprising the steps of providing an article of clothing in a washing machine, and contacting said article of clothing during a wash sub-cycle of said washing machine with a fabric care composition described herein.

These and other aspects of the present disclosure will become more apparent upon reading the following detailed description of the disclosure.

### DETAILED DESCRIPTION

Features and benefits of the various embodiments of the present disclosure will become apparent from the following description, which includes examples of specific embodiments intended to give a broad representation of the invention. Various modifications will be apparent to those skilled in the art from this description and from practice of the invention. The scope of the present disclosure is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, terms such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

The term “perfume-containing particle” refers to a particle comprising one or more perfume ingredients, such as free perfumes, pro-perfumes, encapsulated perfumes (including perfume microcapsules), and the like. Preferably, such perfume-containing particles contain perfumes encapsulated in perfume microcapsules, especially friable perfume microcapsules.

The term “aspect ratio” refers to the ratio of the longest dimension of the particles over its shortest dimension. For example, when such particles have a hemispherical or compressed hemispherical shape, the aspect ratio is the ratio between the based diameter of the particles over its height.

The term “consisting essentially of” means that the composition contains less than about 1%, preferably less than about 0.5%, of ingredients other than those listed.

Further, the term “substantially free of” or “substantially free from” means that the indicated material is present in the amount of from 0 wt % to about 1 wt %, preferably from 0 wt % to about 0.5 wt %, more preferably from 0 wt % to about 0.2 wt %. The term “essentially free of” means that the indicated material is present in the amount of from 0 wt % to about 0.1 wt %, preferably from 0 wt % to about 0.01 wt %, more preferably it is not present at analytically detectable levels.

As used herein, all concentrations and ratios are on a weight basis unless otherwise specified. All temperatures herein are in degrees Celsius (C) unless otherwise indicated. All conditions herein are at 20° C. and under the atmospheric pressure, unless otherwise specifically stated. All polymer molecular weights are determined by weight average number molecular weight unless otherwise specifically noted.

Since there are many tasks to be accomplished in laundering clothes such as, cleaning, stain removal, brightness, fabric restoration, softness, scent, static control, and the like, one could in theory provide a separate product for each task to be done and the consumer could completely customize the kind and amount of each benefit agent that is applied in the wash. This could become overly complicated for the consumer and require the consumer to dispense and store multiple products in his or her laundering area and combine in the optimal quantities. There are thought to be particular combinations of tasks and benefits to be obtained that the consumer might like to have available in a single product for which the dose can be customized by the consumer.

The mixed particles of the fabric care composition described herein also can provide additional benefits and solve other challenges the consumer may encounter. For example, consumers want to add additive fabric care composition into the washing machine together with detergent, prior the wash sub-cycle, so as to save time and energy. But there are challenges for such practice. For example, the cationic material contained in the additive composition may potentially coacervate the anionic detergent components, or acidic materials in the additive composition may impede the activity of enzymes. The composition described herein expected and surprisingly solve these problems by providing mixed particles with different shapes and surface area which could lead to multiple releases (due to different soluble time) through the wash. It is especially helpful for materials that are either incompatible with the detergent or will be washed away with detergent.

There is higher probability that the benefit agent will deposit on fabric when it is continuously released through the wash cycle. It is also discovered that the particles described herein which is extruded can have a longer dissolution period to even last until the rinse cycle.

Furthermore, the mixed particles of the present disclosure could provide desired solubility or active release via specific shape design and active choices so that the actives do not compete with detergent. In sum, the varying shape, surface area and bead density enable continuous active/benefit agent release through the wash, with the convenience of adding all the materials at the beginning of the wash cycle.

Many consumers also desire to use naturally sourced fabric care products or fabric care products that contain a large fraction of or are entirely made up of naturally sourced ingredients. The composition described herein may provide fabric care additives which are naturally sourced or include a large fraction of naturally sourced ingredients.

### Fabric Care Composition

The fabric care composition described herein comprise a plurality of first particles and a plurality of second particles. Preferably, the fabric care composition comprises from 50% to 95% by weight of the plurality of the first particles and from 5% to 50% by weight of the plurality of the second particles. More preferably, the fabric care composition comprises from 70% to 90% by weight of the plurality of the first particles and from 10% to 30% by weight of the plurality of the second particles.

Each of the first particles has a mass from 5 mg to 500 mg; preferably has a mass from 5 mg to 450 mg, preferably from 10 mg to 200 mg, and more preferably from 15 mg to 150 mg. Each of the first particles has a maximum dimension of less than about 10 mm, e.g., a maximum dimension of less than 9.5 mm, preferably from 1 mm to 9 mm, more preferably from 2 mm to 8 mm. Each of the first particles may have a volume from about 0.003 cm³ to about 0.15 cm³, preferably from about 0.005 cm³ to about 0.12 cm³.

The second particles have different mass and different size from the first particles. Preferably, the second particles have a larger mass and larger size than the first particles.

In a preferred embodiment, each of the second particles has a mass from 5 mg to 5 g, or from 10 mg to 2 g, preferably from 20 mg to 1g, and more preferably from 25 mg to 500 mg.

The mass ratio between each of the first particles and each of the second particles is from more than 1:1 to 1:50, and preferably from more than 1:1 to 1:20, and more preferably from more than 1:1 to 1:10.

Each of the first particles has a first shape selected from the group consisting of hemispherical, compressed hemispherical, heightened hemispherical, lentil shaped, or oblong. Compressed hemispherical refers to a shape corresponding to a hemisphere that is at least partially flattened such that the curvature of the curved surface is less, on average, than the curvature of a hemisphere having the same radius. A compressed hemispherical pastille can have a ratio of height to diameter of from about 0.01 to about 0.49, alternatively from about 0.1 to about 0.45, alternatively from about 0.2 to about 0.4. Heightened hemispherical refers to a shape corresponding to a hemisphere that is at least partially heightened such that the curvature of the curved surface is more, on average, than the curvature of a hemisphere having the same radius. A heightened hemispherical pastille can have a ratio of height to diameter of from about more than 0.5 to about 0.9, alternatively from about 0.55 to about 0.75, alternatively from about 0.6 to about 0.7. Lentil shaped refers to the shape of a lentil bean. Oblong shaped refers to a shape having a maximum dimension and a maximum secondary dimension orthogonal to the maximum dimension, wherein the ratio of maximum dimension to the maximum secondary dimension is greater than about 1.2. An oblong shape can have a ratio of maximum dimension to maximum secondary dimension greater than about 1.5. An oblong shape can have a ratio of maximum dimension to maximum secondary dimension greater than about 2. Oblong shaped particles can have a maximum dimension from about 2 mm to about 6 mm, a maximum secondary dimension of from about 2 mm to about 4 mm.

In a preferred embodiment, substantially all of said first particles have a substantially flat base and a height (H) measured orthogonal to said base and together said first particles have a distribution of heights, wherein said distribution of heights has a mean height between 1 mm and 5 mm and a height standard deviation less than 0.3 mm.

In a preferred embodiment, the maximum dimension of the second particle is no less than the maximum dimension of the first particles, and preferably the ratio of the maximum dimension of the first particle and the second particles is from 1:1 to 1:10, and preferably from 1:1 to 1:5, and more preferably from 1:1.1 to 1:3.

In a preferred embodiment, the volume ratio of each first particle to each second particle is from 1:1 to 1:50, preferably from 1:1.1 to 1:25, more preferably from 1:1.5 to 1:10.

In a preferred embodiment, substantially all of said second particles have a maximum dimension and a maximum secondary dimension orthogonal to the maximum dimension, wherein the ratio of maximum dimension to the maximum secondary dimension is greater than about 1.2.

In a preferred but not necessary embodiment of the present disclosure, each of the first particles and/or the second particles have a density lower than water, so that they can float on water. For example, such particles may have a density ranging from about 0.5 g/cm³ to about 0.98 g/cm³, preferably from about 0.7 g/cm³ to about 0.95 g/cm³, more preferably from about 0.8 g/cm³ to about 0.9 g/cm³.

In a preferred embodiment, the second particles have different shape from the first particles. Preferably, each of said second particles has an aspect ratio of less than 10, preferably from more than 1 to 7, more preferably from more than 1 to 5. The term “aspect ratio” refers to the ratio of the longest dimension of the particles over its shortest dimension. This particular aspect ratio defines the second particle having a good compatibility with the first particles when mixed uniformly in a package and shows good flowability during manufacturing or storage. At the same time, the mixed first and second particles in the composition of the present disclosure exhibit good stability against segregation.

The second particles of the present disclosure may have any shape different from the first particles, selected from the group consisting of spherical, cylindrical, disc, circular, lentil-shaped, oblong, cubical, rectangular, star-shaped, flower-shaped, and any combinations thereof.

Either the first particle or the second particles can comprise a fabric care active agent selected from the group consisting of perfume, fabric softener active, cationic polymer, dye transfer inhibitor, malodor control agent, and mixtures thereof. Either the first particle or the second particles can comprise surfactant or nil surfactant. Either the first particle or the second particles can further comprise carrier agents which is selected from polyethylene glycol, polymer, proteins, sugar, starch, saccharides, polysaccharides, water-soluble or water dispensable fillers, and combinations thereof.

### Perfume Ingredients

The first particles and/or the second particles in the composition of the present disclosure may comprise from about 0.1 wt % to about 20 wt %, preferably from about 0.5 wt % to about 15 wt %, more preferably from about 1 wt % to about 10 wt % of one or more perfume ingredients, such as free perfumes, pro-perfumes, encapsulated perfumes (including perfume microcapsules), and the like.

In one embodiment, the first particles and/or the second particles comprise free perfumes and are substantially or essentially free of encapsulated perfumes. In such an embodiment, each particle may comprise no more than about 25%, preferably no more than about 20% (e.g., from about 0.1% to about 20%), more preferably from about 0.5% to about 15%, most preferably from about 1% to about 10%; alternatively, from about 9% to about 20%; alternatively, from about 10% to about 18%; alternatively, from about 11% to about 13%, alternatively, combinations thereof, of free perfumes by weight of such particle.

In another embodiment, the first particles and/or the second particles each comprise encapsulated perfumes (i.e., perfumes carried by a carrier material such as starch, cyclodextrin, silica, zeolites or clay or in form of perfume microcapsules), but are substantially or essentially free of free perfumes. Preferably, the particles comprise perfume oil encapsulated in perfume microcapsules (PMCs), which are preferably friable (verses, for example, moisture activated PMCs) but can also be moisture activated. For purposes of the present disclosure, the term “perfume microcapsules” or “PMC” describes both perfume microcapsules and perfume nanocapsules. In such an embodiment, the particles may each comprise from about 0.1% to 20%, preferably from about 0.5% to about 10%, more preferably from about 1% to about 5%, alternatively from about 4% to about7%, alternatively from about 5% to about 7%, alternatively combinations thereof, of perfume microcapsules (preferably friable perfume microcapsules) by weight of the particles.

In yet another embodiment, each of the first particles and/or the second particles comprises both free perfumes and encapsulated perfumes (preferably in form of perfume microcapsules, and more preferably in form of friable perfume microcapsules), e.g., at a weight ratio ranging from about 1:5 to about 5:1, alternatively from about 1:4 to about 4:1, further alternatively from about 1:3 to about 3:1. In another embodiment, the first particles and/or the second particles may comprise from about 1% to about 10%, alternatively from about 2% to about 12%, alternatively from about 2% to about 8%, alternatively from about 3% to about 8%, alternatively from about 4% to about 7%, alternatively from about 5% to about 7%, alternatively combinations thereof, of PMCs by weight of the particles. In this embodiment, the perfume encapsulated by the PMC may comprise from about 0.6% to about 4% of perfume by weight of the particles.

In one embodiment, the PMCs comprise melamine/formaldehyde shells, which are commercially available from Appleton, Quest International, International Flavor & Fragrances, or other suitable sources. In a preferred embodiment, the shells of the PMCs are coated with polymer to enhance the ability of the PMCs to adhere to fabric.

### Softening Agent

### Quaternary Ammonium Compound

The first particles and/or the second particles can comprise a quaternary ammonium compound so that the particles can provide a softening benefit to laundered fabrics through the wash, and in particular during the wash sub-cycle of a washer having wash and rinse sub-cycles. The quaternary ammonium compound (quat) can be an ester quaternary ammonium compound. Suitable quaternary ammonium compounds include but are not limited to, materials selected from the group consisting of ester quats, amide quats, imidazoline quats, alkyl quats, amidoester quats and combinations thereof. Suitable ester quats include but are not limited to, materials selected from the group consisting of monoester quats, diester quats, triester quats and combinations thereof. Suitable quaternary ammonium compound can include those described in U.S. Pat. No. 10,487,293 B2, incorporated herein by reference.

### Silicone

The first particles and/or the second particles can comprise about 0.1% to about 60% of silicone by weight of the particles. In a preferably embodiment the first particles comprise free of silicone, while the second particles comprise silicone. The second particles can comprise about 3% to about 50% of silicone by weight of the second particles. The second particles can comprise about 10% to about 40% of silicone by weight of the second particles. The second particles can comprise about 20% to about 35% of silicone by weight of the second particles. The second particles can comprise about 28% to about 32% of silicone by weight of the second particles.

The first particles can comprise less than 0.1% by weight of the first particles silicone. The first particles can comprise less than 1% by weight of the first particles silicone. The first particles can comprise less than 3% by weight of the first particles silicone.

### Cationic Polymer

The first particles and/or the second particles can comprise a cationic polymer. Cationic polymers can provide the benefit of a deposition aid that helps to deposit onto the fabric quaternary ammonium compound and possibly some other benefit agents that are contained in the particles.

The particles can comprise about 0.5% to about 10% by weight cationic polymer. Optionally, the particles can comprise about 0.5% to about 5% by weight cationic polymer, or even about 1% to about 5% by weight, or even about 2% to about 4% by weight cationic polymer, or even about 3% by weight cationic polymer. Without being bound by theory, it is thought that the cleaning performance of laundry detergent in the wash decreases with increasing levels of cationic polymer in the particles and acceptable cleaning performance of the detergent can be maintained within the aforesaid ranges.

The cationic polymer can have a cationic charge density more than about 0.05 meq/g (meq meaning milliequivalents), to 23 meq/g, preferably from about 0.1 meq/g to about 4 meq/g. even more preferably from about 0.1 meq/g to about 2 meq/g and most preferably from 0.1meq/g to about 1 meq/g.

The above referenced cationic charge densities can be at the pH of intended use, which can be a pH from about 3 to about 9, optionally about 4 to about 9.

Non-limiting examples of cationic polymers are cationic or amphoteric, polysaccharides, proteins and synthetic polymers. Cationic polysaccharides include cationic cellulose derivatives, cationic guar gum derivatives, chitosan and its derivatives and cationic starches. Cationic polysaccharides have a molecular weight from about 1,000 to about 2 million, preferably from about 100,000 to about 800,000. Suitable cationic polysaccharides include cationic cellulose ethers, particularly cationic hydroxyethylcellulose and cationic hydroxypropylcellulose.

Specific examples of cationic polymer include those described in U.S. Pat. No. 10,487,293 B2, incorporated herein by reference.

### Dye Transfer Inhibitor

The first particles and/or the second particles can comprise a dye transfer inhibitor. The dye transfer inhibitor can be a graft copolymer.

The graft copolymer can comprise: (a) a polyalkylene oxide which has a number average molecular weight of from about 1000 to about 20000 Da and is based on ethylene oxide, propylene oxide, or butylene oxide; and (b) a vinyl ester derived from a saturated monocarboxylic acid containing from 1 to 6 carbon atoms; wherein (a) and (b) are present at a weight ratio of (a):(b) of from about 1:0.1 to about 1:2. The polyalkylene oxide can be based on ethylene oxide. The vinyl ester can be derived from a saturated monocarboxylic acid containing from 1 to 3 carbon atoms. The vinyl ester is vinyl acetate or a derivative thereof. (a) and (b) can be present at a weight ratio of (a):(b) of from about 1:0.1 to about 1:1.7. From about 1mol % to about 60mol % of (b) can be hydrolyzed. The graft copolymer can be a graft copolymer VAc-gPEG4000 available from BASF, Ludwigshafen, Germany. Synthesis of graft copolymer VAc-gPEG4000 is described in WO 01/05874.

The graft copolymer can comprise (a) a polyalkylene oxide which has a number average molecular weight of from about 1000 to about 20000 Da and is based on ethylene oxide, propylene oxide, or butylene oxide; (b) N-vinylpyrrolidone; and (c) vinyl ester derived from a saturated monocarboxylic acid containing from 1 to 6 carbon atoms; wherein (a) and (b) are present at a weight ratio of (a): (b) of from about 1:0.1 to about 1:1; wherein by weight, (a) is present in an amount greater than (c); wherein order of addition of (b) and (c) in graft polymerization is immaterial. The polyalkylene oxide can be based on ethylene oxide. The vinyl ester is derived from a saturated monocarboxylic acid containing from 1 to 3 carbon atoms. The vinyl ester can be vinyl acetate or a derivative thereof. (a) and (b) can be present at a weight ratio of (a):(b) of from about 1:0.2 to about 1:0.7. (a) and (c) can be present at a weight ratio of (a):(c) of from about 1:0.1 to about 1:0.8. (b) and (c) can be present at a weight ratio of (b):(c) of from about 1:0.1 to about 1:4. From about 1mol % to about 60mol % of (c) can be hydrolyzed.

Each of the first or second particles can comprise from about 0.1% to about 50%, optionally from about 0.1% to about 40%, optionally from about 0.1% to about 20%, optionally about 1% to about 20%, optionally from about 0.1% to about 15%, optionally from about 0.1% to about 12%, optionally from about 1% to about 15%, optionally from about 2% to about 20%, optionally from about 8% to about 10% by weight dye transfer inhibitor.

### Malodor Control Agent

The fabric care active agent can be a malodor control agent. The malodor control agent can be any material capable of absorbing, suppressing, neutralizing, and or eliminating malodors.

The malodor control agent can be selected from the group consisting of host-guest compound, malodor binding material, malodor neutralizing material, and combinations thereof. The malodor control agent can be selected from the group consisting of a-cyclodextrin, a-cyclodextrin derivatives, b-cyclodextrin, b-cyclodextrin derivatives, g-cyclodextrin, g-cyclodextrin derivatives, d-cyclodextrin, d-cyclodextrin derivatives, zinc salts of C16-C18 fatty acids, and mixtures thereof.

Each of the first and/or second particles can comprise from about 0.1% to about 20% by weight of said particles malodor control agent, optionally from about 0.1% to about 15%, optionally from about 0.1% to about 12%, optionally from about 1% to about 15%, optionally from about 2% to about 20% by weight of said particles malodor control agent.

### Anti-Caking Agent

An anti-caking agent can be provide to reduce the propensity for the particles to stick to one another after manufacture. The anti-caking agent can be applied to the exterior surface of the particles. The anti-caking agent can be a desiccant. The anti-caking agent can be selected from the group consisting of silica, zeolite, unmodified corn starch, cellulose, rock flour, clay, and combinations thereof. The anti-caking agent can be stearates of calcium and magnesium, silica, silicates, talc, flour, starch. The anti-caking agent can be selected from the group consisting of tricalcium phosphate, powdered cellulose, magnesium stearate, sodium bicarbonate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminum silicate, calcium aluminosilicate, bentonite, aluminum silicate, stearic acid, polydimethylsiloxane, and combinations thereof.

Each of the first or second particles can comprise from about 0.1% to about 10% by weight, optionally from about 0.1% to about 7%, optionally from about 0.5% to about 7%, optionally from about 0.1% to about 3%, optionally from about 0.1% to about 2%, by weight anti-caking agent.

The particles of the present disclosure may be substantially free of laundry active and/or fabric softener actives. To reduce costs and avoid formulation capability issues, one aspect of the disclosure may include the first and second particles that are essentially free or completely free of laundry actives and/or fabric softener actives. In one embodiment, each of the first and second particles comprises less than about 3%, alternatively less than about 2%, alternatively less than about 1%, alternatively less than about 0.1% by weight of the particles, of laundry actives and/or fabric softener actives (or combinations thereof). Laundry actives may include detergent surfactants, detergent builders, bleaching agents, enzymes, mixtures thereof, and the like. It is particularly preferred that the first particles and/or the second particles of the present disclosure are substantially free of or essentially free of surfactants, because the presence of such surfactants may speed up dissolution of the perfume particles in water, which is undesirable in the context of the present disclosure.

Depending on the application, the particles of the present disclosure may comprise a solvent selected from the group consisting of glycerin, polypropylene glycol, isopropyl myristate, dipropylene glycol, 1,2-propanediol, and PEG having a weight average molecular weight less than 2,000, and mixtures thereof.

The particles can further comprise an antioxidant. The antioxidant can help to promote stability of the color and odor of the particles over time between production and use. The particles can comprise between about 0.001% to about 2%, preferably between 0.01% to about 1%, more preferably between about 0.05% to about 0.5% by weight of such antioxidant. The antioxidant can be butylated hydroxytoluene.

### Carrier

Each of the first particles comprises a first water-soluble carrier, and each of the second particles comprises a second water-soluble carrier, wherein the first water-soluble carrier and the second water-soluble carrier is each selected from the group consisting of polyalkylene glycol, inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, and combinations thereof. In some embodiments, each of said particle comprises polyalkylene glycol water-soluble carriers. In some embodiments, each of said particle comprises polyalkylene glycol and at least an additional water-soluble carrier.

Preferably, the polyalkylene glycol water-soluble carrier can be materials selected from polyethylene glycol, polypropethylene glycol, ethylene oxide/propylene oxide block copolymers, and combinations thereof. For example, the water-soluble carrier can be polyethylene glycol (PEG). PEG has a relatively low cost, may be formed into many different shapes and sizes, minimizes free perfume diffusion, and dissolves well in water. The term “polyethylene glycol” or “PEG” as used herein includes homopolymers containing repeating units of ethylene oxide, random copolymers containing repeating units of ethylene oxide and propylene oxide, block copolymers containing blocks of polyethylene oxide and polypropylene oxide, and combinations thereof.

The first or second particles can comprise about 25% to about 99% by weight of the particles of PEG. Optionally, the particles can comprise from about 35% to about 99%, optionally from about 40% to about 99%, optionally from about 50% to about 99%, optionally combinations thereof and any whole percentages or ranges of whole percentages within any of the aforementioned ranges, of PEG by weight of the respective particles. Preferably, The PEG present in the particles is characterized by a weight average molecular weight (Mw) ranging from about 2,000 to about 20,000 Daltons, optionally from about 2000 to about 15000 Da, alternatively from about 4000 to about 20000 Da, alternatively from about 4000 to about 15000 Da, alternatively from about 4000 to about 12000 Da, alternatively from about 5000 to about 11000 Da, alternatively from about 6000 to about 10000 Da, alternatively from about 7000 to about 9000 Da, alternatively combinations thereof. Suitable PEGs include homopolymers commercially available from BASF under the tradenames of Pluriol® E 8000.

Alternatively, the polyalkylene glycol water-soluble carrier can be an ethylene oxide-propylene oxide-ethylene oxide (EOx₁POyEOx₂) triblock copolymer, which preferably has an average ethylene oxide chain length of between about 2 and about 90, preferably about 3 and about 50, more preferably between about 4 and about 20 ethylene oxide units, and an average propylene oxide chain length of between 20 and 70, preferably between 30 and 60, more preferably between 45 and 55 propylene oxide units. More preferably, the ethylene oxide-propylene oxide-ethylene oxide (EOx₁POyEOx₂) triblock copolymer has a molecular weight of from about 2000 to about 30,000 Daltons, preferably from about 3000 to about 20,000 Daltons, more preferably from about 4000 to about 15,000 Daltons.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOx₁POyEOx₂) triblock copolymer improve cleaning.

Suitable ethylene oxide—propylene oxide—ethylene oxide triblock copolymers are commercially available under the Pluronic series from the BASF company, or under the Tergitol L series from the Dow Chemical Company. A particularly suitable material is Pluronic® PE 9200. Other suitable materials include Pluronic® F38, F68 and F108.

The polyalkylene glycol water-soluble carrier also included “end capped” polyalkylene glycol. Typically, polyalkylene glycol has two —OH groups at both ends of the polymer chain, “end capped” means at least one or both of the —OH groups are reacted and connected to end capping organic group different from the polyalkylene glycol. Preferably, the end capping organic group R connected to the —OH groups of the polyalkylene glycol via an ether bond (—O—R) and/or ester bond (—O—(C═O)—R), where R is a linear or branched C₁-C₃₀ alkyl group, a cycloalkyl group with 5 to 9 carbon atoms, a C₆-C₃₀ arylalkyl group, a C₆-C₃₀ alkylaryl group. More preferably, R is a linear or branched C₁-C₃₀ alkyl group, even more preferably a linear C₁-C₆ alkyl group and even more preferably a methyl (CH₃).

Examples of suitable “end capped” polyalkylene glycol include a polyethylene glycol fatty alcohol ether of formula:

H₃C—(CH₂)ₜ—O—[CH₂—CH₂—O]_{q}—(CH₂)ₜ—CH₃
wherein
q is based on a molar average, a number from 30 to 250.
t is based on a molar average, a number from 0 to 30.

Examples of suitable “end capped” polyalkylene glycol include a polyethylene glycol fatty alcohol esters of formula:

H₃C—(CH₂)ₜ—(C═O)—O—[CH₂—CH₂—O]_{q}—(C═O)—(CH₂)ₜ—CH₃
wherein
q is based on a molar average, a number from 30 to 250.
t is based on a molar average, a number from 0 to 30.

### Other Water-Soluble Carriers

The water-soluble carriers present in the particle of the present disclosure may also be selected from inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, etc.

Suitable inorganic alkali metal salts can be selected from the group consisting of sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium silicate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium silicate, and combinations thereof.

Suitable inorganic alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium silicate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium silicate, and combinations thereof.

Organic salts, such as organic alkali metal salts and organic alkaline earth metal salts, contain carbon.

Suitable organic alkali metal salts can be selected from the group consisting of sodium acetate, sodium citrate, sodium lactate, sodium tartrate, sodium ascorbate, sodium sorbate, potassium acetate, potassium citrate, potassium lactate, potassium tartrate, potassium ascorbate, potassium sorbate, and combinations thereof.

Suitable organic alkali metal salts can be selected from the group consisting of calcium acetate, calcium citrate, calcium lactate, calcium tartrate, calcium ascorbate, calcium sorbate, magnesium acetate, magnesium citrate, magnesium lactate, magnesium tartrate, magnesium ascorbate, magnesium sorbate, and combinations thereof.

Carbohydrates may be selected from the group consisting of monosaccharides, disaccharides, oligosaccharides, polysaccharides and derivatives thereof, and combinations thereof.

Suitable monosaccharides may be selected from the group consisting of erythrose, ribose, arabinose, xylose, glucose, isoglucose, dextrose, galactose, mannose, erythrulose, ribulose, fructose, sorbose, rhamnose, fucose, deoxyribose, ribose, and combinations thereof.

Suitable disaccharides sugar may be selected from the group consisting of sucrose, maltose, lactose, isomaltose, trehalose, cellobiose, melibiose, gentiobiose, and combinations thereof.

Suitable oligosaccharides maybe selected from the group consisting of maltotriose, raffinose, stachyose, and combinations thereof.

Preferably the sugar is selected from the group consisting of fructose, glucose, isoglucose, galactose, raffinose, and combinations thereof. More preferably the sugar comprises or is sucrose.

Suitable polysaccharides may be selected from the group consisting of homopolysaccharides, heteropolysaccharides, and combinations thereof.

Suitable polysaccharides may be selected from the group consisting of starch, corn starch, wheat starch, rice starch, potato starch, tapioca starch, modified starch, cellulose, carboxymethyl cellulose, methyl cellulose, ethyl cellulose, propyl cellulose, hydroxyethyl cellulose, hydroxypropyl cellulose, cellulose esters, cellulose amides, glycogen, pectin, dextrin, maltodextrin, corn syrup solids, alginates, xyloglugans, xylan, glucuronoxylan, arabinoxylan, mannan, dextran, glucomannan, galactoglucomannan, xanthan, carrageenan, locust bean gum, Arabic gum, tragacanth, and combinations thereof.

Carbohydrate derivatives may be selected from the group consisting of aminosugars, deoxysugars, sugar alcohols, sugar acids, and combinations thereof.

Suitable sugar alcohol may be selected from the group consisting of sorbitol, mannitol, isomalt, maltitol, lactitol, xylitol, erythritol, and combinations thereof. Preferably the sugar alcohol is selected from the group consisting of mannitol, sorbitol, xylitol and combinations thereof.

The water-soluble carrier may be selected from the group consisting of clay, zeolites, silica, silicates, citric acid and salts thereof, fatty alcohol, glyceryl diester of hydrogenated tallow, and combinations thereof.

The water-soluble carrier may be a water-soluble polymer selected from the group consisting of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyglycerol esters, acrylamide; polyvinyl acetates; polycarboxylic acids and salts thereof, sulfonated polyacrylates, polyaminoacids or peptides, polyamides, polyacrylamide, copolymers of maleic/acrylic acids, gelatin, and combinations thereof.

### Plasticizer Polyol

The particles can comprise from 0% to 3% by weight a plasticizer polyol. The particles can comprise from 0% to 3% by weight a plasticizer polyol that is liquid at 20 C and 1 atmosphere of pressure. The plasticizer polyol, which is optional, can aid with mixing the formulation components of the particles. An overabundance of plasticizer polyol can impede formation and stability of the particles. The plasticizer polyol can be glycerin. The plasticizer polyol can be dipropylene glycol. The plasticizer polyol can be propylene glycol. The plasticizer polyol can be selected from the group consisting of glycerin, dipropylene glycol, propylene glycol, and mixtures thereof.

### Method Of Making Particles

Rotoforming can be a practical process for forming first and second particles from a melt. One suitable rotoforming device is a Sandvik ROTOFORM 3000 having a 750 mm wide 10 m long belt. The distributor of a rotoforming device is a rotating cylinder. The cylinder can have 2 mm diameter apertures set at a 10 mm pitch in the cross machine direction and 9.35 mm pitch in the machine direction. The cylinder can be set at approximately 3 mm above the belt. The belt speed and rotational speed of the cylinder can be set at about 10 m/min.

First and second particles can also be made using other approaches. For instance, granulation or press agglomeration can be appropriate. In granulation, the precursor material is compacted and homogenized by rotating mixing tools and granulated to form first and second particles. For precursor materials that are substantially free of water, a wide variety of sizes of first and second particles can be made.

In press agglomeration, the precursor material is compacted and plasticized under pressure and under the effect of shear forces, homogenized and then discharged from the press agglomeration machine via a forming/shaping process. Press agglomeration techniques include extrusion, roller compacting, pelleting, and tableting.

The precursor material can be delivered to a planetary roll extruder or twin screw extruder having co-rotating or contra-rotating screws. The barrel and the extrusion granulation head can be heated to the desired extrusion temperature. The precursor material can be compacted under pressure, plasticized, extruded in the form of strands through a multiple-bore extrusion die in the extruder head, and sized using a cutting blade. The bore diameter of the extrusion header can be selected to provide for appropriately sized first and second particles. The extruded first and second particles can be shaped using a mould to provide for particles that have any particular desired shape.

Optionally, the extrusion and compression steps may be carried out in a low-pressure extruder, such as a flat die pelleting press, for example as available from Amandus Kahl, Reinbek, Germany. Optionally, the extrusion and compression steps may be carried out in a low pressure extruder, such as a BEXTRUDER, available from Hosokawa Alpine Aktiengesellschaft, Augsburg, Germany.

The first and second particles can be made using roller compacting. In roller compacting the precursor material is introduced between two rollers and rolled under pressure between the two rollers to form a sheet of compactate. The rollers provide a high linear pressure on the precursor material. The rollers can be heated or cooled as desired, depending on the processing characteristics of the precursor material. The sheet of compactate is broken up into small pieces by cutting. The small pieces can be further shaped, for example by using a spheronizer.

### Method of Usage

The first particles and second particles disclosed herein can be conveniently employed to treat laundry articles. The steps of the process can be to provide such first particles and second particles comprising the formulation components disclosed herein. A dose of the first particles and second particles can be placed in a dosing cup. The dosing cup can be the closure of a package containing the particles. The dosing cup can be a detachable and attachable dosing cup that is detachable and attachable to a package containing the first particles and second particles or to the closure of such package. The dose of first particles and second particles in the dosing cup can be dispensed into a washing machine. The step of dispensing the particles in the washing machine can take place by pouring the first particles and second particles into the washing machine or placing the dosing cup and the particles contained therein into the washing machine.

The composition of first particles and second particles disclosed herein can be convenient for the consumer to dose into a washing machine. For instance, the consumer can pour the composition from a package that contains the first particles and second particles. The first particles and second particles can be a mixture of such particles in a single chamber of the package.

Optionally, the consumer can pour the first particles and second particles into a measuring cup that is separate from the package or in which the composition is provided or into a measuring cup that is part of the package in which the composition is provided. The measuring cup can be a closure of the package in which the composition is provided. The measuring cup can be attachable and detachable from the closure of the package in which the composition is provided.

The composition of the mixture of first particles and second particles can have a coefficient of uniformity of less than 2. Having a coefficient of uniformity of less than 2 can help reduce the potential for the particles when packaged together in a single chamber of a package to segregate as compared to mixtures of particles having a coefficient of uniformity greater than 2. Particle size, coefficient of uniformity, D50, and D10, are measured according to ASTM D6913-04 (2009)e1.

### Test Method

The Dispersion Time is determined according to the DISPERSION TEST METHOD described in US2017/035389, incorporated herein by reference. For shorter wash cycles, particles having a shorter Dispersion Time may preferable.

The first particles and second particles can have different Dispersion Times. For instance, the first particles can have a Dispersion Time that is shorter or longer than the Dispersion Time of the second particles. It can be practical to have the first particles have a shorter Dispersion Time than the second particles. In a case that the first particles are perfume particles, and the second particles are softening particles containing silicone, this can provide early room bloom of perfume as the first particles disperse in the wash and then significant release of silicone from the second particles to be deposited on the fabric. If for certain wash conditions, cycles, silicone, and perfumes it is desirable for the silicone to be released before the perfume, then the second particles can have a shorter Dispersion Time than the first particles.

The mean particle size of the silicone in the composition of the present disclosure can be determined using MEAN PARTICLE SIZE TEST METHOD as described in US2017/035389 (incorporated herein by reference).

Onset of melt is determined using the ONSET OF MELT TEST METHOD as described in US2017/035389 (incorporated herein by reference).

Flow Test and Heap Segregation Simulation Test are described in detail below.

### EXAMPLES

### Example 1: Flow Test

Set up: A cylinder of radius 40 mm is filled with 200 g of examples of the composition according to the present disclosure. This example of the composition consists of 80% of a plurality of first particles and 20% of a plurality of second particles. Each of the first particles has a shape of hemispherical with radius of 2.5 mm. Different sizes of second particles are prepared, wherein the mass of the second particles is from 4 to 10 times of the mass of the first particles, with aspect ratios of the second particles ranging from 1 to 10. Specifically, Examples A to D are samples of the composition wherein the mass ratio of the second particle and the first particle is 4, and the aspect ratio of the second particle is 1, 4, 7 and 10 respectively. Examples E to H are samples of the composition wherein the mass ratio of the second particle and the first particle is 10, and the aspect ratio of the second particle is 1, 4, 7 and 10 respectively. Either the first or second particles has density of 1.2 g/cm3.

The composition of the present disclosure (containing mixed first and second particles) insert into the cylinder, giving a total mass of 200 g. Allow to settle under gravity. After filling the cylinder, a plug in the bottom of the cylinder is removed giving a centered hole of radius 10 mm and allow material to flow out. The cylinder was attached to an electrical balance with stand. The remaining particle weight was tracked with weight loss by the electrical balance. Each test was repeated 3 times. The 3 times average of mixed particles remaining weight in the cylinder on the 4th second is reported in below Table 1.

TABLE 1
Flow test simulation examples and result

| Exam- | Mass ratio of second | Aspect Ratio of | Remaining |
|---|---|---|---|
| ples | particle to first particle | Second particle | Weight/g |
| A | 4 | 1 | 107 |
| B | 4 | 4 | 173 |
| C | 4 | 7 | 184 |
| D | 4 | 10 | 196 |
| E | 10 | 1 | 162 |
| F | 10 | 4 | 174 |
| G | 10 | 7 | 186 |
| H | 10 | 10 | 190 |

### Example 2: Boxed Heap Segregation Test Setup

A stoppered conical funnel is filled with 500 g of samples of composition containing the first particles and the second particles. The funnel is with 295 mm diameter, 275 mm height and 30 mm opening. The Examples A to H are prepared the same as in Example 1: Flow Test. Once filled, the stopper is removed and the samples of composition flow from the funnel into a narrow slot, forming a heap inside the box. The narrow slot is with 30 mm width, 305 mm length and 325 mm height. The heap is divided into 18 equally spaced intervals and calculate the mass fraction of second particles in each interval. The standard deviation of the 18 mass fraction data is calculated as indicator of segregation between the second particles and the first particles. Each test was repeated 3 times. The 3 times average results are listed in Table 2 below.

TABLE 2
Boxed Heap Segregation Test Examples and results

| | Mass ratio of | Second | Standard Deviation |
|---|---|---|---|
| Exam- | second particle to | particle Aspect | (Std Dev of second |
| ples | first particle | Ratios | particle fraction) |
| A | 4 | 1 | 0.0661 |
| B | 4 | 4 | 0.0443 |
| C | 4 | 7 | 0.0500 |
| D | 4 | 10 | 0.0796 |
| E | 10 | 1 | 0.1058 |
| F | 10 | 4 | 0.0580 |
| G | 10 | 7 | 0.0811 |
| H | 10 | 10 | * |

* The “/mixture” blocked the opening and cannot flow out from cylinder.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any composition disclosed or claimed herein or that it alone, or in any combination with any other reference or references, teaches, suggests or discloses any such composition. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of the present disclosure.

What is claimed is:

1. A fabric care composition, comprising:
a plurality of first particles, wherein:
each of said first particles has a mass from 5 mg to 500 mg,
each of said first particles has a maximum dimension of less than about 10 mm, and
each of said first particles has a first shape selected from the group consisting of hemispherical, compressed hemispherical or heightened hemispherical; and
a plurality of second particles, wherein:
each of said second particles has a mass equal to or larger than the mass of the first particle,
each of said second particles has a second shape which is different from the first shape of the first particle, and
each of said second particles has an aspect ratio of more than 1 and less than 10;
wherein the plurality of first particles and the plurality of second particles are in a package.

2. The fabric care composition according to claim 1, wherein the plurality of the first particles is present in amount of from 50% to 95% by weight in the composition, and the plurality of the second particles is present in amount of from 5% to 50% by weight in the composition.

3. The fabric care composition according to claim 1, wherein:
the mass of each of the second particles is from 5 mg to 5 g; and
the mass ratio between each of the second particles and each of the first particles is from 1:1 to 50:1.

4. The fabric care composition according to claim 1, wherein each of said second particles has an aspect ratio from more than 1 to 7.

5. The fabric care composition according to claim 1, wherein the maximum dimension of the second particle is no less than the maximum dimension of the first particles, and the ratio of the maximum dimension of the first particle and the second particles is from 1:1 to 1:10.

6. The fabric care composition according to claim 1, wherein the volume ratio of each first particle to each second particle is from 1:1 to 1:50.

7. The fabric care composition according to claim 1, wherein:
substantially all of said first particles have a substantially flat base and a height (H) measured orthogonal to said base and together said first particles have a distribution of heights, and
said distribution of heights has a mean height between 1 mm and 5 mm and a height standard deviation less than 0.3 mm.

8. The fabric care composition according to claim 1, wherein:
substantially all of said second particles have a maximum dimension and a maximum secondary dimension orthogonal to the maximum dimension, and
the ratio of maximum dimension to the maximum secondary dimension is greater than about 1.2.

9. The fabric care composition according to claim 1, wherein:
each of the first particles has a mass from 5 mg to 450 mg; and
each of the second particles has a mass from 10 mg to 2 g.

10. The fabric care composition according to claim 1, wherein each of said first particles and said second particles comprises one or more ingredients selected from a perfume ingredient, a water-soluble carrier, a surfactant, a fabric softener active, cationic polymer, malodor control agent, colorants, enzymes, bleaching agents, and combinations thereof.

11. The fabric care composition according to claim 10, wherein:
each of said first particles comprises a first perfume ingredient and a first water-soluble carrier, and each of said second particles comprises a second perfume ingredient and a second water-soluble carrier,
the first perfume ingredient and the second perfume ingredient comprises free perfumes, or friable perfume microcapsules, or both, and
the first water-soluble carrier and the second water-soluble carrier is each selected from the group consisting of polyalkylene glycol, inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, and combinations thereof.

12. A fabric care composition, comprising:
50% to 95% by weight of a plurality of first particles, wherein:
each of said first particles has a mass from 5 mg to 500 mg;
each of said first particles has a maximum dimension of less than about 10 mm, and
each of said first particles has a first shape selected from the group consisting of hemispherical, compressed hemispherical or heightened hemispherical, wherein said first particles comprise a perfume ingredient; and
5% to 50% by weight of a plurality of second particles, wherein:
each of said second particles has a mass equal to or larger than the mass of the first particle;
each of said second particles has an aspect ratio of more than 1 and less than 10, and
said second particles comprise one or more ingredients selected from perfume ingredient, water-soluble carrier, surfactant, fabric softener active, cationic polymer, malodor control agent, colorants, enzymes, bleaching agents, and combinations thereof;
wherein the plurality of first particles and the plurality of second particles are in a package.

13. A process for treating an article of clothing comprising the steps of:
providing an article of clothing in a washing machine; and
contacting said article of clothing during a wash sub-cycle of said washing machine with a fabric care composition according to claim 1.
